(19) United States
(12) Patent Application Publication
(10) Pub. No.: US 2018/0077381 A1
(43) Pub. Date: Mar. 15, 2018

(54) Five-Sense Experience Kiosk

(71) Applicant: WITH International, Inc., Rolling Meadows, IL (US)

(72) Inventors: Joon Hwan Tae, Elk Grove, IL (US); David Yang, Rolling Meadows, IL (US)

(21) Appl. No.: 15/265,006

(22) Filed: Sep. 14, 2016

(51) Int. Cl. H04N 7/14; H04N 13/04

(52) U.S. Cl. CPC H04N 7/142; H04N 13/0454

(57) ABSTRACT

An embodiment of Five-sense Experience Kiosk concept is provided for delivering five-senses: audio, touch, video, smell and taste to a user. A Five-Sense Experience Kiosk with a user can experience audio, touch, video, smell and taste from the Kiosk. Video image can be in either 2-D or 3-D mode. The system of the invention optionally comprises a means for storing, retrieving or analyzing information, and/or outputting to a 2-D or 3-D printer.

### STATEMENT REGARDING FEDERALLY SPONSORED RESEARCH OR DEVELOPMENT

Not Applicable

### FIELD

The present invention relates to a five-sense experience kiosk, more specifically, a five-sense experience kiosk with five receivers: audio receiver, touch receiver, video receiver or camera, smell receiver and taste receiver and five-sense outputs: audio output or speaker, touch output, video output or monitor in 2-D or 3-D, smell output and taste output. The present invention optionally comprises a means for storing, retrieving or analyzing information, and/or outputting to a 2-D or 3-D printer.

### BACKGROUND

Standalone video terminals have been popular for many years and these terminals continue to change as technology improves. The capabilities of such device expand as the cost of the computer components and memory decreases. A significant advance was made by adopting touch-screens as both an input device and an output display. Various applications are provided on device, including teleconferencing, email, telephone, calendar, to mention a few.

Although the field of video-communication has been under development for a while, a number of processes, procedures and interactive communications systems have certain disadvantages that become apparent when used in a wide variety of complex and ever-changing technological innovations and commercial environments. For example, there are growing needs for delivering additional sensor inputs like touch, smell and taste in addition to audio and video signals.

Typical System and Kiosk for Commerce is described in U.S. Pat. No. 7,774,2333. However, these previous proposals do not suggest any modern solution to the problems encountered with conventional kiosks.

Also, There is an unmet need for a more versatile and unified kiosk system having the capability of providing users with a wider variety of sensor inputs and other information. Existing kiosks and terminals have limited capabilities over the growing requirements for ever-growing number of potentially available technologies.

Furthermore, the present invention provides a modern appearance that reflects a significant technological advancement.

### SUMMARY

It is one of the objects of the present invention to provide a system and method to address the unmet needs in the art in the area of an individual's personal, educational, medical and health care needs as well as in the area of industrial needs.

It is also one of the objects of the invention to provide a kiosk that can provide audio, touch, video, smell and taste.

It is a further one of the objects of the present invention to provide a smart video system that contains an automatically adjustable video image, such as, for example, 2-D image or 3-D image depending on the video input or video mode.

In one embodiment, the present invention provides a system for use by a user comprising a kiosk that comprises: (a) a kiosk user; (b) video output either 2-D or 3-D image; (c) audio output or speaker; (d) touch output: (f) taste output: (g) smell output: wherein the system is configured to accept input from the five-sensor input data transmit center, and to provide output to one or more five-sensor output kiosk systems. The data comes from a data center that comprises: (a) audio sensor or mike (b) touch sensor (c) 2-D or 3-D video camera (d) smell sensor (e) taste sensor (f) data transmit server.

In a further embodiment, there is provided a system as above, at least one of the one or more video cameras deliver either 2-D or 3-D image. The system of the invention optionally comprises a means for storing, retrieving or analyzing information, and/or outputting to a 2-D or 3-D printer.

In another embodiment, the present system may be designed to allow a user to stand or sit in front of the screen or to be a stand-alone unit or a wall-mounted system or a desk top unit, or to be incorporated into a retail shelving system.

Other objects, features or advantages of the present invention will be clear to a person of ordinary skill in the art upon review of the description herein. Such other objects, features and advantages are considered part of the present invention.

### BRIEF DESCRIPTION OF THE DRAWINGS

Various embodiments of the invention are disclosed in the following detailed description and accompanying drawings.

FIG. 1 is a perspective and systematic view of a five-sense experience kiosk according to the present invention to show five-sense receptors and five-sense outputs in the 2-D or 3-D display Kiosk.

### DETAILED DESCRIPTION OF THE INVENTION

The detailed description of the operation of Five-Sense Experiencing Kiosk and magnets is explained in this section with reference to the accompanying drawings.

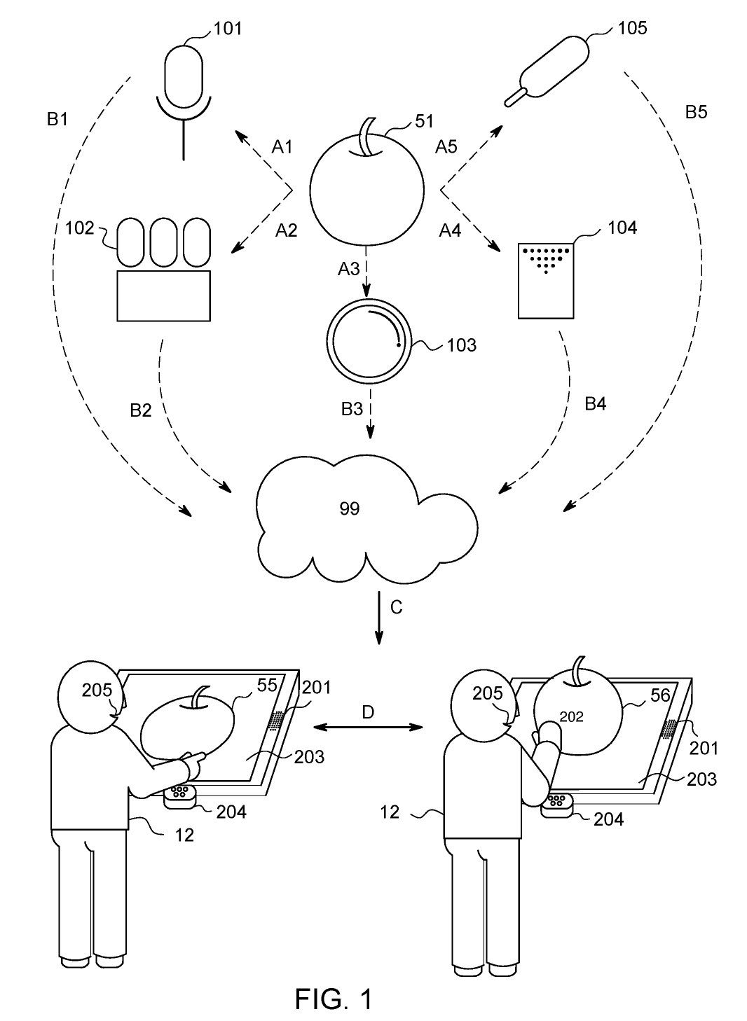

According to FIG. 1, the perspective and systematic view of a five-sense experience kiosk according to the present invention to show five-sense receptors and five-sense outputs in 2-D (55) or 3-D display (56) is shown.

There are audio input or mike (101), touch sensor (102), video camera (103), smell sensor (104) and taste sensor (105) around the the actual object (51).

The audio input sensor (101) accepts audio (a1). The touch sensor (102) accepts touch input (a2). The video camera (103) accepts video input (a3). The smell sensor (104) accepts smell input (a4). The taste sensor (105) accepts taste (a5). The combined input or sensor data of audio (b1), touch (b2), video (b3), smell (b4) and taste (b5) are transmitted from the five-sensor input to the five-sensor output kiosk with the user (12) through the data send and receiver server (99).

There are audio output or speaker (201), touch output (202), video output or video monitor (203) in either 2-D image (55) or 3-D image (56), smell output (204) and taste output (205).

1. A Five-Sense Experiencing Kiosk comprising of five sensors and five outputs.

2. Five-Sense Experiencing Kiosk of claim 1, wherein said audio sensor, touch sensor, video camera, smell sensor and taste sensor are attached to Five-Sense Experiencing Kiosk.

3. Five-Sense Experiencing Kiosk of claim 1, wherein said speaker, touch output, video monitor, smell output and taste output are attached to Five-Sense Experiencing Kiosk.

4. Five-Sense Experiencing Kiosk of claim 1, wherein said video monitor is either 2-D display or 3-D display.

5. Five-Sense Experiencing Kiosk of claim 1, wherein said system optionally comprises a means for storing, retrieving or analyzing information.

6. Five-Sense Experiencing Kiosk of claim 1, wherein said system optionally comprises a means for outputting to a 2-D or 3-D printer.

7. Five-Sense Experiencing Kiosk of claim 1, wherein said system is optionally configured to accept input from one five-sensor input data transmit centers, and to provide output to one or more five-sensor output kiosk systems.
